(19) United States
(12) Patent Application Publication
(10) Pub. No.: US 2025/0224006 A1
(43) Pub. Date: Jul. 10, 2025

(54) TRANSMISSION, ELECTRIC DRIVE DEVICE, AND VEHICLE SYSTEM

(71) Applicant: DENSO CORPORATION, Kariya-city (JP)

(72) Inventors: YOSHINORI AKITSU, Kariya-city (JP); KIYOSHI FUJII, Kariya-city (JP)

(21) Appl. No.: 19/088,502

(22) Filed: Mar. 24, 2025

Related U.S. Application Data
(63) Continuation of application No. PCT/JP2023/031832, filed on Aug. 31, 2023.

(30) Foreign Application Priority Data
Sep. 27, 2022 (JP) 2022-154091

(51) Int. Cl. F16D 51/22; B60K 7/00; B60K 17/12; F16D 65/22; F16D 121/20; F16D 125/28

(52) U.S. Cl. CPC F16D 51/22; B60K 7/0007; B60K 17/12; F16D 65/22; F16D 2121/20; F16D 2125/28

(57) ABSTRACT

A transmission includes: an input shaft; an output shaft that extends in an extending direction of the input shaft; a transmission mechanism that is configured to change a rotational speed of rotation outputted from the input shaft, and to transmit the rotation to the output shaft; a case that receives the input shaft, the output shaft and the transmission mechanism; and a brake mechanism that is configured to apply a braking torque to at least one of the input shaft and the output shaft. The brake mechanism is received at an inside of the case.

### CROSS REFERENCE TO RELATED APPLICATIONS

This application is a continuation application of International Patent Application No. PCT/JP2023/031832 filed on Aug. 31, 2023, which designated the U.S. and claims the benefit of priority from Japanese Patent Application No. 2022-154091, filed on Sep. 27, 2022. The entire disclosures of all of the above applications are incorporated herein by reference.

### TECHNICAL FIELD

The present disclosure relates to a transmission, an electric drive device including the transmission, and a vehicle system including the electric drive device.

### BACKGROUND

A transmission integrated with an electric motor has been previously proposed.

The transmission includes: an input shaft; an output shaft that extends in an extending direction of the input shaft; and a transmission mechanism that is configured to change a rotational speed of rotation outputted from the input shaft, and to transmit the rotation to the output shaft. The input shaft, the output shaft and the transmission mechanism are received at an inside of the case.

### SUMMARY

This section provides a general summary of the disclosure, and is not a comprehensive disclosure of its full scope or all of its features.

According to the present disclosure, there is provided a transmission that includes:
an input shaft;
an output shaft that extends in an extending direction of the input shaft;
a transmission mechanism that is configured to change a rotational speed of rotation outputted from the input shaft, and to transmit the rotation to the output shaft;
a case that receives the input shaft, the output shaft and the transmission mechanism; and
a brake mechanism that is configured to apply a braking torque to at least one of the input shaft and the output shaft, wherein the brake mechanism is received at an inside of the case.

With the above configuration, it is possible to minimize the increase in the size of the transmission.

According to the present disclosure, there is also provided an electric drive device to be installed in a vehicle. The electric drive device includes: the transmission; and an electric motor that is configured to apply a rotational torque to the input shaft of the transmission.

According to the present disclosure, there is further provided a vehicle system that includes the electric drive device as one of a plurality of electric drive devices in the vehicle system.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing an overall structure of an unmanned carrier vehicle according to one embodiment.

FIG. 2 is a side view of the unmanned carrier vehicle.

FIG. 3 is a perspective view of a speed reducer.

FIG. 4 is a diagram showing internal structures of an electric motor and the speed reducer.

FIG. 5 is a diagram showing the internal structure of the speed reducer in a state where second and third case members are removed.

FIG. 6 is a diagram showing the internal structure of the speed reducer in a state where the third case member is removed.

FIG. 7 is a diagram showing the internal structure of the speed reducer in a state where the third case member is removed.

FIG. 8 is a diagram showing a drum brake mechanism.

FIG. 9 is a diagram showing the drum brake mechanism in a braking state.

FIG. 10 is a diagram showing the drum brake mechanism in a non-braking state.

FIG. 11 is a top view showing a solenoid coil and its periphery at an inside of the case.

FIG. 12 is a diagram showing an overall structure of an unmanned carrier vehicle according to another embodiment.

FIG. 13 is a side view of the unmanned carrier vehicle according to the other embodiment.

### DETAILED DESCRIPTION

A transmission integrated with an electric motor has been previously proposed.

The transmission includes: an input shaft; an output shaft that extends in an extending direction of the input shaft; and a transmission mechanism that is configured to change a rotational speed of rotation outputted from the input shaft, and to transmit the rotation to the output shaft. The input shaft, the output shaft and the transmission mechanism are received at an inside of the case.

A brake mechanism, which applies a braking force to at least one of the input shaft and the output shaft of the transmission, may be required. When the brake mechanism is provided in the transmission, there is a concern that a size of the transmission may become larger.

According to the present disclosure, there is provided a transmission that includes:
an input shaft;
an output shaft that extends in an extending direction of the input shaft;
a transmission mechanism that is configured to change a rotational speed of rotation outputted from the input shaft, and to transmit the rotation to the output shaft;
a case that receives the input shaft, the output shaft and the transmission mechanism; and
a brake mechanism that is configured to apply a braking torque to at least one of the input shaft and the output shaft, wherein the brake mechanism is received at an inside of the case.

With the above configuration, it is possible to minimize the increase in the size of the transmission.

Hereinafter, an embodiment of a transmission and an electric drive device having the transmission will be described with reference to the drawings. The electric drive device is applied to a compact mobility. The compact mobility of the present embodiment is a vehicle that travels at a low speed, for example, 10 km/h or less. The compact mobility refers specifically to an unmanned carrier vehicle in a form of an electric vehicle used for transporting goods in a workplace such as a factory production line or warehouse. More specifically, it refers to an Automatic Guided Vehicle (AGV).

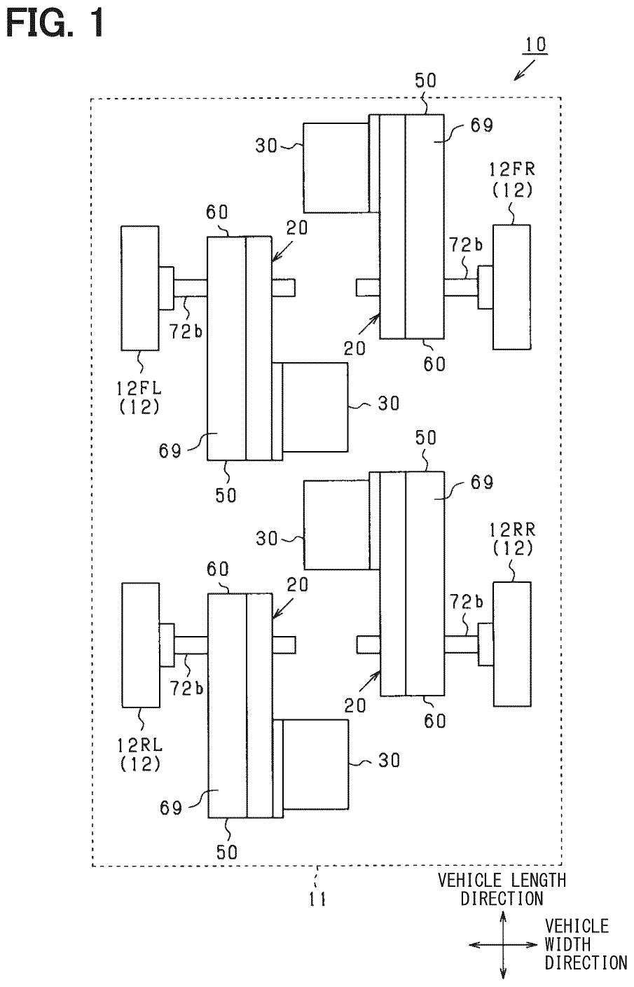

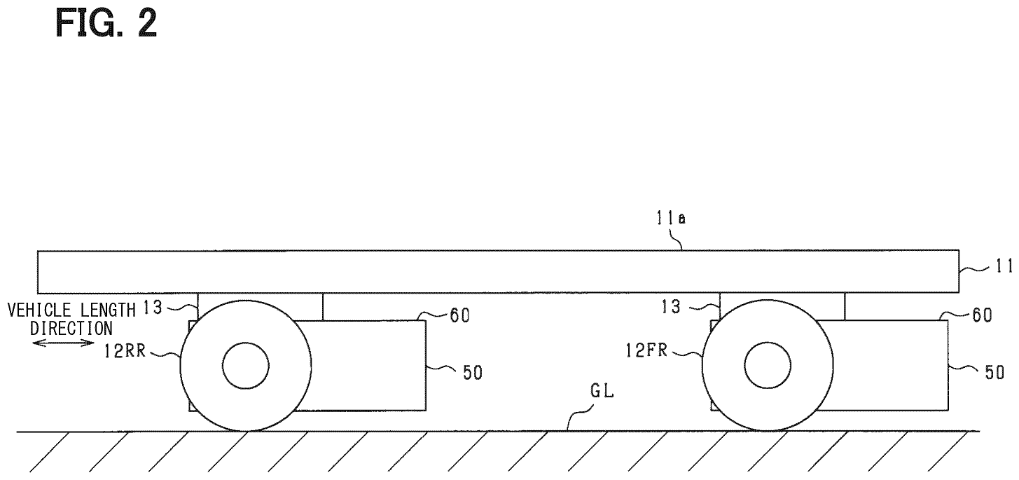

As shown in FIGS. 1 and 2, the unmanned carrier vehicle 10 includes a vehicle body 11 and a plurality of drive wheels 12. In this embodiment, the plurality of drive wheels 12 include: a right front wheel 12FR; a left front wheel 12FL arranged alongside the right front wheel 12FR in a vehicle width direction; a right rear wheel 12RR; and a left rear wheel 12RL arranged alongside the right rear wheel 12RR in the vehicle width direction. In other words, the unmanned carrier vehicle 10 has two sets (two pairs) of right and left drive wheels. For convenience, FIG. 2 shows only the configuration of the right drive wheels among the left and right drive wheels.

The vehicle body 11 has a structure in which a dimension measured in a vehicle length direction is larger than a dimension measured in the vehicle width direction. An upper surface of the vehicle body 11 serves as a loading surface 11a on which transported goods are placed. The loading surface 11a is generally parallel to a traveling road surface GL on which the unmanned carrier vehicle 10 travels. In FIG. 1, an outer peripheral edge of the vehicle body 11 is depicted with a dotted line, and part of the structure below the loading surface 11a of the vehicle body 11 is depicted with a solid line.

The vehicle body 11 is equipped with a vehicle system that includes: a plurality of electric drive devices 20 that are configured to rotate the drive wheels 12, respectively, to move the unmanned carrier vehicle 10; a plurality of steering mechanisms 13 that are configured to steer the drive wheels 12, respectively; a host ECU (not shown) that is configured to control the driving of the unmanned carrier vehicle 10; and an electricity storage device (not shown) that is configured to serve as an electric power source of the electric drive devices 20 and the host ECU. The electricity storage device is a secondary battery, such as a lithium-ion storage battery. The electricity storage device is, for example, placed at a lower portion of the vehicle body 11.

The electric drive device 20 is individually provided for each of the drive wheels 12. In the present embodiment, each electric drive device 20 has basically an identical configuration. The electric drive device 20 includes: an electric motor 30 that serves as a rotational power source for the drive wheel 12; and a speed reducer 50 that is configured to amplify an output torque outputted from the electric motor 30, and to transmit it to the drive wheel 12.

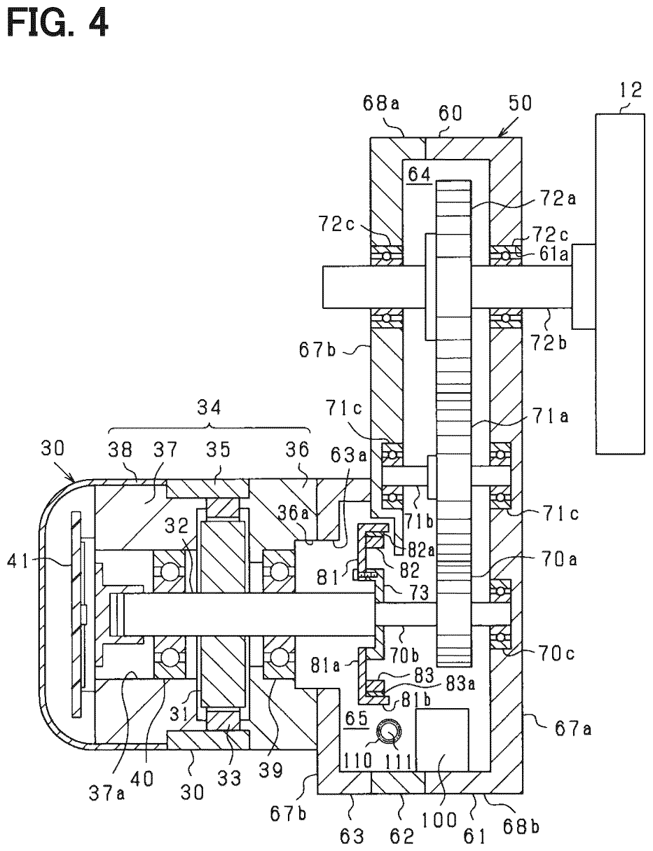

First, the electric motor 30 will be described with reference to FIG. 4. FIG. 4 is a longitudinal cross-sectional view showing the electric motor 30 and the speed reducer 50.

The electric motor 30 includes: a rotor 31 which has a plurality of field magnetic poles (e.g., a plurality of permanent magnets); a shaft 32 which is fixed to the rotor 31; and a stator 33 which is placed on a radially outer side of the rotor 31. A rotational center axis of the shaft 32 extends in a horizontal direction. The stator 33 includes: a stator core (not shown); and a plurality of stator windings (not shown) which are wound around the stator core.

The electric motor 30 includes a motor housing 34. The motor housing 34 includes a tubular portion 35, a first connecting portion 36, a second connecting portion 37 and a cover portion 38. The tubular portion 35 is shaped in an elongated tubular form elongated in an extending direction of the shaft 32 (i.e., a direction in which the shaft 32 extends), and specifically, the tubular portion 35 is shaped in a cylindrical tubular form. The first connecting portion 36 is coupled to a first end part of the tubular portion 35 facing in a longitudinal direction of the tubular portion 35, and the second connecting portion 37 is coupled to a second end part of the tubular portion 35 facing in the longitudinal direction. The rotor 31 and the stator 33 are received in a cylindrical space surrounded by the tubular portion 35, the first connecting portion 36 and the second connecting portion 37. The stator 33 is fixed to an inner peripheral surface of the tubular portion 35. It should be noted that the motor housing 34 is not limited to having a cylindrical cross-section and may, for example, have a rectangular cross-section.

The first connecting portion 36 has a first opening 36a. A first motor bearing 39 is installed at the first opening 36a. Furthermore, the second connecting portion 37 has a second opening 37a, and a second motor bearing 40 is installed at the second opening 37a. In the present embodiment, each bearing 39, 40 is a rolling bearing having an inner race, an outer race, and a plurality of rolling elements held between the inner race and the outer race. A first end portion of the shaft 32 is rotatably supported by the first motor bearing 39, and a second end portion of the shaft 32 is rotatably supported by the second motor bearing 40.

The cover portion 38 is installed to a part of the second connecting portion 37 which is opposite to the tubular portion 35 in a longitudinal direction of the motor housing 34. A control circuit board 41 is installed in a space surrounded by the second connecting portion 37 and the cover portion 38. In the present embodiment, the control circuit board 41 is arranged such that a plate surface of the control circuit board 41 is perpendicular to the extending direction of the shaft 32. The control circuit board 41 has: an inverter electrically connected to the stator windings; and a motor ECU serving as a controller device. The inverter includes semiconductor switches for upper and lower arms for three phases. The inverter is configured to convert a DC electric power supplied from the electricity storage device of the unmanned carrier vehicle 10 into an AC electric power through switching control of the semiconductor switches of the upper and lower arms of the inverter and supplies the AC electric power to the stator windings. The motor ECU includes a microcomputer as its main component. The motor ECU is configured to perform the switching control of the inverter to control the control amount (e.g., torque) of the electric motor 30 to a corresponding command value transmitted from the host ECU.

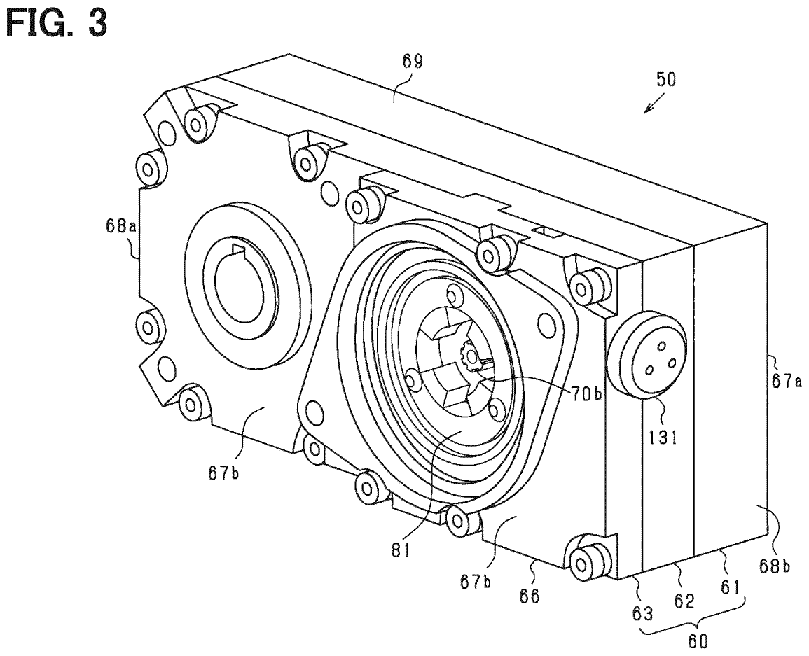

Next, the speed reducer 50 will be described with reference to FIGS. 3 to 5. For convenience, a portion of the case shown in FIG. 4 is simplified from the case shown in FIG. 3. The speed reducer 50 is configured to amplify the input torque outputted from the shaft 32, and to output it to the drive wheel 12. In the present embodiment, the speed reducer 50 is elongated in the vehicle length direction to limit an increase in a size of the electric drive device 20 measured in the vehicle width direction. The speed reducer 50 includes a case 60 coupled to the motor housing 34.

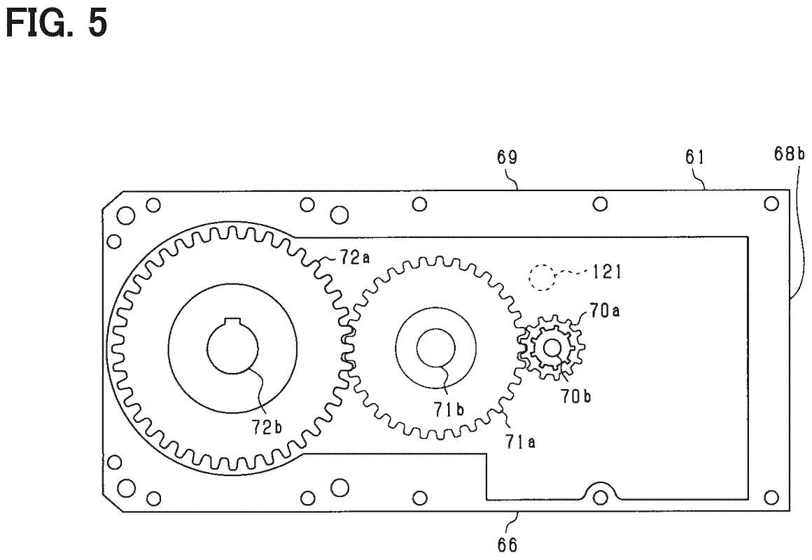

The case 60 is shaped in a generally rectangular parallelepiped form that has a longitudinal direction perpendicular to an input shaft 70b and an output shaft 72b. The case 60 includes: a bottom plate 66 shaped in a generally elongated rectangular form; first and second longitudinal walls 67a, 67b that extend in the vertical direction from two long sides, respectively, of the bottom plate 66; first and second transverse walls 68a, 68b that extend in the vertical direction from two short sides, respectively, of the bottom plate 66; and a top plate 69. The case 60 includes a first case member 61, a second case member 62 and a third case member 63. The output shaft 72b extends to an outside of the case 60 from an output-side opening 61a formed at the first longitudinal wall 67a of the case 60. Furthermore, the input shaft 70b extends toward an opening (serving as an input-side opening) 63a formed at the second longitudinal wall 67b of the case 60. FIG. 5 is a diagram showing an internal structure of the speed reducer 50 in a state where the second and third case members 62, 63 are removed. For convenience, some components are omitted from the illustration in FIG. 5.

A first space 64, which is surrounded by the first case member 61 and the second case member 62, receives a plurality of spur gears of the speed reducer (transmission) mechanism. Specifically, the first space 64 receives an input-side gear 70a, an intermediate gear 71a and an output-side gear 72a which are arranged one after another in the longitudinal direction of the case 60. The input-side gear 70a has the input shaft 70b, and the intermediate gear 71a has an intermediate shaft 71b. Furthermore, the output-side gear 72a has the output shaft 72b. The input shaft 70b, the intermediate shaft 71b and the output shaft 72b extend in the same direction as the shaft 32. In the present embodiment, a rotational center axis of the input shaft 70b, a rotational center axis of the intermediate shaft 71b, a rotational center axis of the output shaft 72b and the rotational center axis of the shaft 32 are all located on a common plane.

The opening 63a is formed at the third case member 63. The shaft 32 is inserted through the opening 63a. The first end portion of the shaft 32 is fixed to a first end portion of the input shaft 70b by, for example, a coupler. A second end portion of the input shaft 70b is rotatably supported by a first bearing 70c (rolling bearing) installed in the first longitudinal wall 67a.

The intermediate shaft 71b of the intermediate gear 71a, which meshes with the input-side gear 70a, is rotatably supported by two second bearings 71c (rolling bearings) installed in the first and second longitudinal walls 67a, 67b, respectively. The output shaft 72b of the output-side gear 72a, which meshes with the intermediate gear 71a, is rotatably supported by two third bearings 72c (rolling bearings) installed in the first and second longitudinal walls 67a, 67b, respectively. The output shaft 72b extends to the outside of the case 60 through the output-side opening 61a of the first longitudinal wall 67a in which the third bearing 72c is installed. The drive wheel 12 is coupled to an end portion of the output shaft 72b.

A diameter of the intermediate gear 71a is larger than a diameter of the input-side gear 70a, and a diameter of the output-side gear 72a is larger than the diameter of the intermediate gear 71a. That is, the diameters of the gears 70a, 71a, 72a, which are received in the first space 64, increase from the input shaft 70b side toward the output shaft 72b side in the longitudinal direction of the case 60. With this configuration, the rotational speed of the output-side gear 72a is reduced compared to the input-side gear 70a, allowing the torque transmitted from the electric motor 30 to the input shaft 70b to be amplified and transmitted to the output shaft 72b.

Returning to the description of FIGS. 1 and 2, each of the electric drive devices 20 is arranged such that the longitudinal direction of the case 60, which constitutes the speed reducer 50, faces in the vehicle length direction. Additionally, each pair of the electric drive devices 20, which are arranged side by side in the vehicle width direction, are positioned such that the output shafts 72b of the pair of electric drive devices 20 are aligned in the vehicle width direction.

As shown in FIG. 2, an upper portion of the case 60 of each electric drive device 20 is coupled to the lower portion of the vehicle body 11 through the corresponding steering mechanism 13. This steering mechanism 13 rotatably supports the electric drive device 20 relative to the vehicle body 11 around an axis perpendicular to the loading surface 11a. This enables the steering of the drive wheels 12. The steering by the steering mechanism 13 is controlled, for example, by the host ECU.

In the example shown in FIG. 1, the electric motor 30 of the electric drive device 20 (serving as a right device), which corresponds to the right front wheel 12FR, and the electric drive device 20 (serving as a left device), which corresponds to the left front wheel 12FL, are arranged such that the electric motors 30 of these electric drive devices 20 are opposed to each other in the vehicle length direction. Furthermore, the electric drive device 20 (serving as a right device), which corresponds to the right rear wheel 12RR, and the electric drive device 20 (serving as a left device), which corresponds to the left rear wheel 12RL, are arranged such that the electric motors 30 of these electric drive devices 20 are opposed to each other in the vehicle length direction. This arrangement reduces the dimension of the unmanned carrier vehicle 10 measured in the vehicle width direction. Additionally, each electric drive device 20 is arranged so that the top plate 69 faces upward.

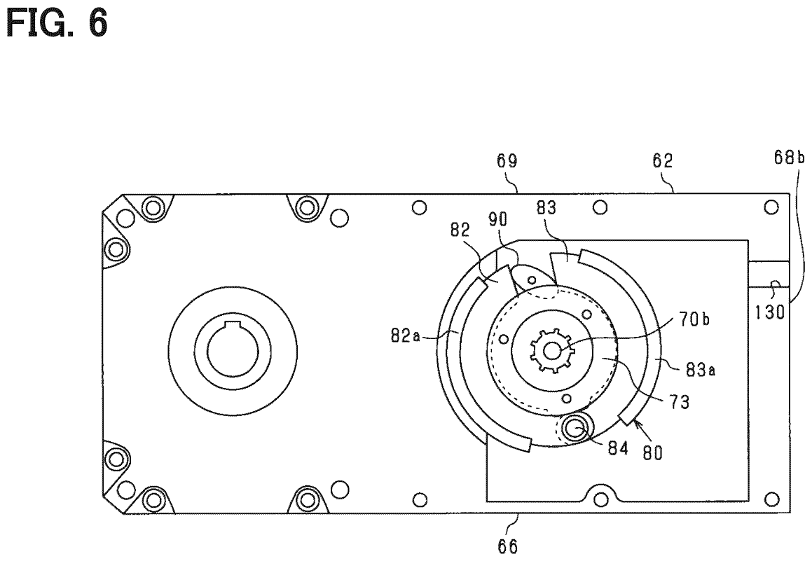

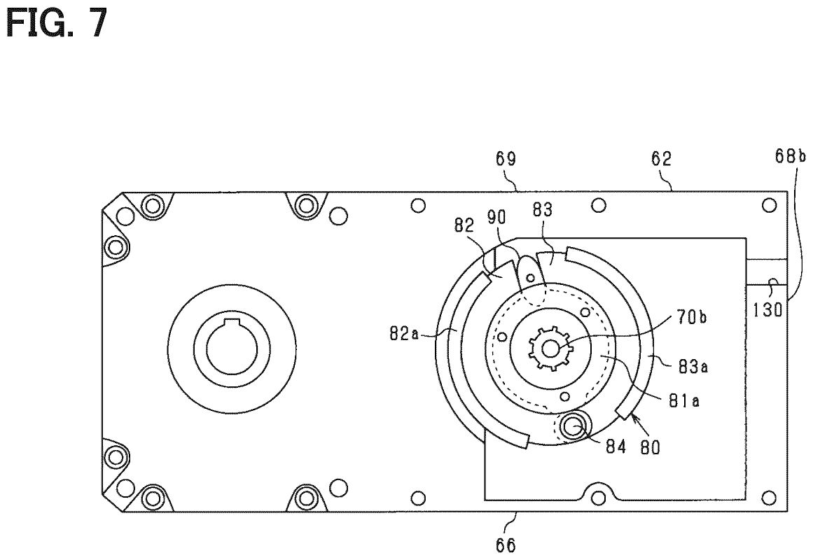

Each electric drive device 20 includes a brake mechanism 80 for braking the corresponding drive wheel 12. Hereinafter, the brake mechanism 80 will be described with reference to FIGS. 4 to 8. FIGS. 6 and 7 are diagrams showing an internal structure of the speed reducer 50 in a state where the third case member 63 is removed. For convenience, some components are omitted from the illustrations in FIGS. 6 and 7.

In the present embodiment, the brake mechanism 80 applies the braking torque only to the input shaft 70b among the input shaft 70b and the output shaft 72b. The torque of the output shaft 72b is larger than the torque of the input shaft 70b. For this reason, the brake mechanism, which applies the braking torque to the output shaft 72b, tends to have an increased size. In contrast, according to the brake mechanism 80 of the present embodiment, a size reduction of the brake mechanism 80 is possible.

The brake mechanism 80 is a drum brake mechanism and includes a brake drum (serving as a rotator) 81 installed on the input shaft 70b. The brake drum 81 is received in a second space 65 surrounded by the second case member 62 and the third case member 63, and is rotated integrally with the input shaft 70b. By receiving the brake mechanism 80 at the inside of the case 60, an increase in the size of the speed reducer 50 can be limited.

A fixing portion 73, which fixes the brake drum 81, is installed to the input shaft 70b on the electric motor 30 side of the input-side gear 70a. The brake drum 81 includes: a circular plate portion 81a fixed to the fixing portion 73 by fastener members such as bolts; and a slidable portion 81b. The slidable portion 81b is shaped in a cylindrical tubular form extending from an outer peripheral edge of the circular plate portion 81a toward the input-side gear 70a in the extending direction of the input shaft 70b. The brake drum 81 is rotated integrally with the input shaft 70b. FIGS. 6 and 7 are diagrams showing a state where the brake drum 81 is removed.

As shown in FIGS. 4, 6 and 7, the brake mechanism 80 includes a first brake shoe 82 and a second brake shoe 83. The first brake shoe 82 is shaped in an arcuate form which is opposed to and extends along one section of an inner peripheral surface of the slidable portion 81b of the brake drum 81. The second brake shoe 83 is shaped in an arcuate form which is opposed to and extends along another section of the inner peripheral surface of the slidable portion 81b that is diametrically opposite to the one section of the inner peripheral surface of the slidable portion 81b, to which the first brake shoe 82 is opposed, about the input shaft 70b.

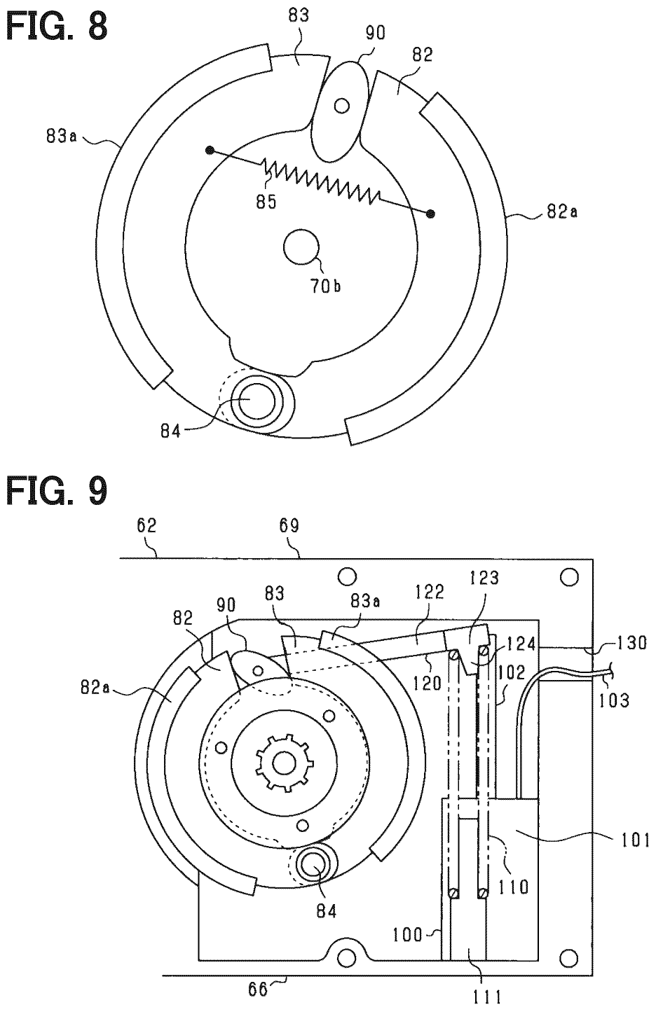

The brake mechanism 80 includes: an anchor 84; and a return spring 85 (see FIG. 8) serving as an urging element. FIG. 8 is a view of the brake mechanism 80 of FIG. 7 seen from a rear side of the brake mechanism 80. The anchor 84 is a member that rotatably supports each of a first end portion of the first brake shoe 82 and a first end portion of the second brake shoe 83 to enable rotation of the first end portion of the first brake shoe 82 and the first end portion of the second brake shoe 83 relative to the case 60 around an axis extending in the extending direction of the input shaft 70b. The anchor 84 is fixed to the case 60 (for example, the first longitudinal wall 67a of the first case member 61).

The return spring 85 is a member that is coupled to each of the brake shoes 82, 83 and applies a resilient force to the first brake shoe 82 and the second brake shoe 83 to move a second end portion of the first brake shoe 82 and a second end portion of the second brake shoe 83 toward each other. Alternatively, a torsion spring may be installed to each of the brake shoes 82, 83 instead of the return spring 85. The torsion spring is provided to encircle the anchor 84. Even in this case, the torsion spring applies a resilient force to the first brake shoe 82 and the second brake shoe 83 to move the second end portion of the first brake shoe 82 and the second end portion of the second brake shoe 83 toward each other.

Each brake shoe 82, 83 is configured such that the first end portion of each brake shoe 82, 83 is diametrically opposed to the second end portion of the brake shoe 82, 83 about the input shaft 70b.

A first lining 82a (serving as a presser) is provided on an arcuate portion of the first brake shoe 82 that is opposed to the slidable portion 81b. A second lining 83a (serving as a presser) is provided on an arcuate portion of the second brake shoe 83 that is opposed to the slidable portion 81b.

Each brake shoe 82, 83 is arranged such that the first end portion of each brake shoe 82, 83 is positioned on the bottom plate 66 side, and the second end portion of each brake shoe 82, 83 is positioned on the top plate 69 side. Additionally, each brake shoe 82, 83 is arranged such that the second end portion of each brake shoe 82, 83 is positioned on the output shaft 72b side of the input shaft 70b in the longitudinal direction of the case 60.

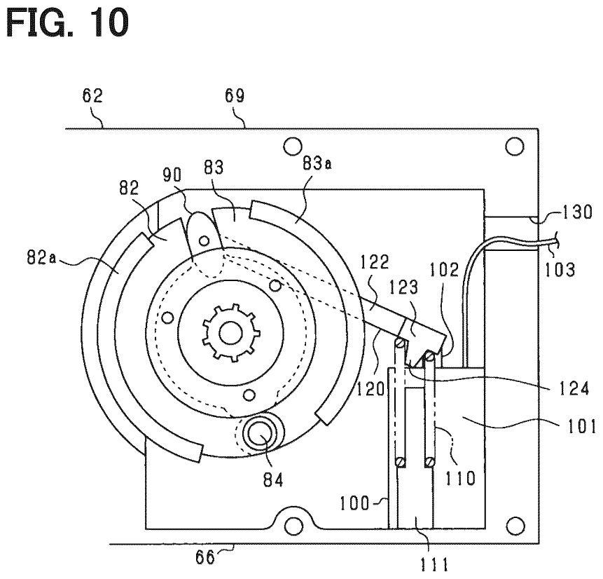

The brake mechanism 80 includes a position shifter that shifts each lining 82a, 83a between a contact state shown in FIG. 6 and a separate state shown in FIG. 7. In the contact state shown in FIG. 6, each lining 82a, 83a is brought in contact with the inner peripheral surface of the slidable portion 81b when the first brake shoe 82 and the second brake shoe 83 are pushed apart by the position shifter to move the second end portion of the first brake shoe 82 and the second end portion of the second brake shoe 83 away from each other. In the separate state shown in FIG. 7, each lining 82a, 83a is separated from the inner peripheral surface of the slidable portion 81b when the second end portion of the first brake shoe 82 and the second end portion of the second brake shoe 83 are moved toward each other by the position shifter. Specifically, as shown in FIGS. 4 to 11, the position shifter includes a cam 90, a solenoid coil 100, a spring 110, a pedestal 111 and a lever 120. FIG. 9 corresponds to FIG. 6, and FIG. 10 corresponds to FIG. 7.

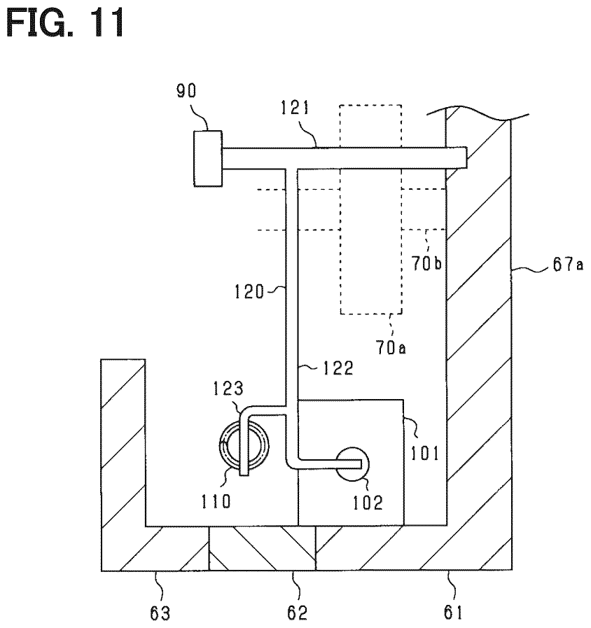

A cross-section of the cam 90 has an elliptical shape, and thereby the cam 90 has a major axis direction extending along a major axis of the cam 90 and a minor axis direction extending along a minor axis of the cam 90. As shown in FIG. 11, the cam 90 is fixed to a first end portion of a support portion 121 which constitutes the lever 120. The support portion 121 extends in the extending direction of the input shaft 70b. A second end portion of the support portion 121 is rotatably supported by the first longitudinal wall 67a to enable rotation of the support portion 121 around an axis extending in the extending direction of the input shaft 70b. Therefore, the cam 90 is rotatably supported by the case 60 to enable rotation of the cam 90 about an axis extending in the extending direction of the input shaft 70b.

The solenoid coil 100 is a linear actuator that includes: a coil unit (serving as a main body) 101 that has a stationary iron core and a coil wound around the stationary iron core; and a movable iron core (serving as a movable portion) 102 that is configured to move in a linear direction relative to the coil unit 101. As shown in FIGS. 4 and 11, the solenoid coil 100 is positioned on a side of the input-side gear 70a where the second transverse wall 68b is placed at the inside of the case 60. Furthermore, the solenoid coil 100 is positioned on a side of the brake drum 81 where the first longitudinal wall 67a is placed at the inside of the case 60.

The coil unit 101 of the solenoid coil 100 is fixed to the case 60 (for example, is fixed to at least one of the bottom plate 66 and the second transverse wall 68b). The movable iron core 102 is configured to move in a direction perpendicular to the longitudinal direction of the case 60 and the input shaft 70b when the coil unit 101 is energized. The energization of the coil unit 101 is executed by, for example, the motor ECU or the host ECU. When the coil unit 101 is energized, the movable iron core 102 is magnetically attracted to and is moved toward the coil unit 101 by a magnetic force of the coil unit 101.

The solenoid coil 100 includes a wiring 103 for supplying the electric power to the coil unit 101. The wiring 103 is configured to supply the electric power from the electricity storage device to the coil unit 101. The wiring 103 is pulled out of the case 60 through a through-hole 130 and a sealing portion 131 (see FIG. 3) provided at the second transverse wall 68b of the case 60. The wiring 103 is positioned on a side of the input-side gear 70a where the second transverse wall 68b is placed at the inside of the case 60. This arrangement limits the wiring 103 from being easily entangled with a rotating member, such as the input-side gear 70a.

The spring (e.g., a compression spring) 110 extends in a moving direction of the movable iron core 102. The spring 110 and the solenoid coil 100 are arranged one after another in the extending direction of the input shaft 70b. A proximal end portion of the spring 110 is installed to the pedestal 111 fixed to the bottom plate 66.

The lever 120 includes: a main connecting portion 122 which extends from the support portion 121 in the longitudinal direction of the case 60; and a secondary connecting portion 123 which branches from an intermediate part of the main connecting portion 122. In the present embodiment, the support portion 121, the main connecting portion 122 and the secondary connecting portion 123 are integrally formed in one-piece, and thereby the lever 120 is formed as a single member. A distal end portion of the main connecting portion 122 is coupled to a distal end portion of the movable iron core 102. In the present embodiment, a connection between the main connecting portion 122 and the movable iron core 102 is configured to enable relative rotation between the main connecting portion 122 and the movable iron core 102 around an axis that extends in the extending direction of the input shaft 70b.

The secondary connecting portion 123 has a seat 124. A distal end portion of the spring 110 is installed to the seat 124.

Next, the operational mode of the brake mechanism 80 will be described. In the following description, the motor ECU or the host ECU will be simply referred to as an ECU.

When the ECU determines that a braking command has been outputted, the ECU stops the supply of the electric power from the electricity storage device to the coil unit 101. Thus, the magnetic attractive force is no longer applied to the movable iron core 102, and thereby the movable iron core 102 is moved away from the coil unit 101 by the restoring force of the spring 110. As a result, the distal end portion of the movable iron core 102 is placed to a first position shown in FIG. 9.

As the distal end portion of the movable iron core 102 approaches the first position, the cam 90 is rotated in a first direction through the lever 120. When the distal end portion of the movable iron core 102 is placed to the first position, the cam 90 is placed in a first state where one primary end portion of the cam 90 facing in the major axis direction contacts the second end portion of the first brake shoe 82, and one secondary end portion of the cam 90 facing opposite to the one primary end portion of the cam 90 in the major axis direction contacts the second end portion of the second brake shoe 83. Thereby, the first brake shoe 82 and the second brake shoe 83 are pushed apart to bring each of the linings 82a, 83a in contact with the inner peripheral surface of the slidable portion 81b of the brake drum 81. Therefore, the braking torque is applied to the input shaft 70b.

The spring 110 applies the resilient force to the lever 120. Here, the spring 110 and the solenoid coil 100 are arranged one after another in the extending direction of the input shaft 70b. Thus, a distance between the cam 90 and the distal end portion of the spring 110 can be increased. Therefore, an amount of rotation of the cam 90 relative to a predetermined amount of up-down movement of an end portion of the lever 120, which is adjacent to the spring 110, can be increased. As a result, appropriate spreading of the brake shoes 82 and 83 is made possible. Additionally, since the distance between the cam 90 and the distal end portion of the spring 110 can be increased, a moment around the main connecting portion 122 can be increased. Furthermore, with the structure in which the spring 110 is arranged in the available space shown in FIGS. 9 and 10, a free length and a diameter of the spring 110 can be increased. With the above structure, the braking torque can be increased, allowing for precise maintenance of the stopped state of the unmanned carrier vehicle 10, for example.

Furthermore, with the structure in which the spring 110 is arranged alongside the solenoid coil 100 in the extending direction of the input shaft 70b, a dimension of the solenoid coil 100 measured in the up-down direction can be reduced compared to a structure in which the spring is provided on the movable iron core 102. Therefore, a size of the unmanned carrier vehicle 10 measured in the up-down direction can be reduced.

According to the present embodiment, in the state shown in FIG. 9, a length of the spring 110 is shorter than a free length of the spring 110, and thereby the spring 110 is in a compressed state. Therefore, each of the linings 82a, 83a can be appropriately urged against the inner peripheral surface of the slidable portion 81b.

In the present embodiment, there is an available space on the top plate 69 side of the input-side gear 70a, which has the smallest diameter among the spur gears of the speed reducer mechanism. To effectively utilize this space, the support portion 121 of the lever 120 is arranged in this space. Thus, the distance between the cam 90 and the distal end portion of the spring 110 can be further increased, and thereby the moment around the main connecting portion 122 can be further increased. As a result, the braking torque can be further increased without increasing the size of the speed reducer 50 measured in the up-down direction.

When the coil unit 101 is not energized, the braking torque is applied to the input shaft 70b. This prevents the unmanned carrier vehicle 10 from moving when it is not in use, such as when it is in storage.

When the ECU determines that the braking command has not been outputted, the ECU executes the supply of the electric power from the electricity storage device to the coil unit 101. As a result, the magnetic attractive force is applied to the movable iron core 102, and thereby the movable iron core 102 is moved toward the coil unit 101 by overcoming the restoring force of the spring 110. As a result, the distal end portion of the movable iron core 102 is placed to a second position shown in FIG. 10.

At this time, as the distal end portion of the movable iron core 102 approaches the second position, the cam 90 is rotated in a second direction, which is opposite to the first direction, through the lever 120. When the distal end portion of the movable iron core 102 is placed in the second position, each of two end portions of the cam 90, which face in the minor axis direction, respectively face the second end portions of the brake shoes 82, 83. The restoring force of the return spring 85 places the cam 90 into the second state where another primary end portion of the cam 90 facing in the minor axis direction contacts the second end portion of the first brake shoe 82, and another secondary end portion of the cam 90 facing opposite to the another primary end portion of the cam 90 in the minor axis direction contacts the second end portion of the second brake shoe 83. Therefore, the second end portion of the first brake shoe 82 and the second end portion of the second brake shoe 83 are moved toward each other to separate each of the linings 82a, 83a from the inner peripheral surface of the slidable portion 81b. As a result, the braking torque is no longer applied to the input shaft 70b.

In the present embodiment, the components, which are necessary for the operation of each brake shoe 82, 83, such as the solenoid coil 100 and the spring 110, are provided in the adjacent space, which is adjacent to the brake shoes 82, 83, rather than between the brake shoes 82, 83. In this way, the outer diameter of the brake drum 81 can be reduced, and thereby the size of the speed reducer 50 can be reduced.

In the present embodiment, a dimension of the vehicle body 11 measured in the vehicle length direction is large, and a dimension of the vehicle body 11 measured in the vehicle width direction is small. Therefore, it is desirable to minimize the dimension of the speed reducer 50 measured in the vehicle length direction. Thus, the mechanism, which includes the spur gears, is used as the speed reducer mechanism, and the components, such as the solenoid coil 100 and the spring 110, are arranged in the space which is adjacent to the input shaft 70b in the vehicle length direction at the inside of the case 60. With this configuration, the dimension of the speed reducer 50, which is measured in the vehicle width direction, can be reduced.

### OTHER EMBODIMENTS

The above-described embodiment may be modified as follows.

In the speed reducer mechanism, a plurality of intermediate gears may be arranged one after another in the longitudinal direction of the case 60. In this case, diameters of the intermediate gears may increase, for example, from the input shaft 70b side toward the output shaft 72b side in the longitudinal direction of the case 60. Additionally, in the speed reducer mechanism, the intermediate gear 71a may not be provided, and the input-side gear 70a and the output-side gear 72a may mesh directly with each other.

The linear actuator is not limited to the solenoid coil and may include: for example, a ball screw (serving as the movable portion); and an electric motor (serving as the main body) that is configured to drive the ball screw in a linear direction.

The support portion 121, which rotatably supports the cam 90, may be a different member which is different from the lever 120.

The brake mechanism is not limited to the drum brake mechanism and may be, for example, a disc brake mechanism. In this case, the brake mechanism may include: a disc rotor (serving as the rotator); brake pads (serving as the pressers); and a brake caliper (serving as the position shifter). The disc rotor is installed to the input shaft and is rotated integrally with the input shaft. The brake pads apply the braking torque to the input shaft when the brake pads contact the disc rotor, and the brake pads stop the application of the braking torque to the input shaft when the brake pads are separated from the disc rotor. The brake caliper is electrically operated to shift the brake pads between: a contact state where the brake pads contact the disc rotor; and a separate state where the brake pads are separated from the disc rotor.

The brake mechanism is not limited to the brake mechanism, which applies the braking torque only to the input shaft, but may be a brake mechanism, which applies the braking torque only to the output shaft, or a brake mechanism, which applies the braking torque to both the input shaft and the output shaft.

The speed reducer mechanism is not limited to the mechanism, which includes the spur gears, but may be a planetary gear mechanism or a cycloidal gear mechanism, where the rotational center axes of the input shaft and the output shaft coincide with each other.

The transmission mechanism installed in the electric drive device is not limited to the speed reducer but may be a speed increaser that is configured to increase the rotational speed of the rotation outputted from the input shaft, and to transmit the rotation to the output shaft.

The electric motor is not limited to the inner rotor type but may be an outer rotor type. Additionally, the electric motor is not limited to the radial gap type but may also be an axial gap type.

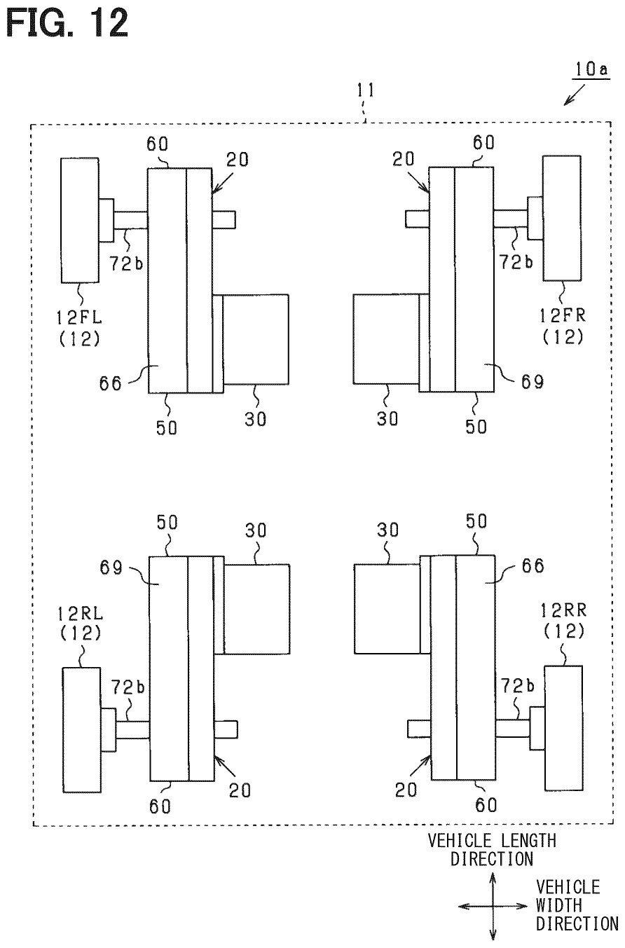

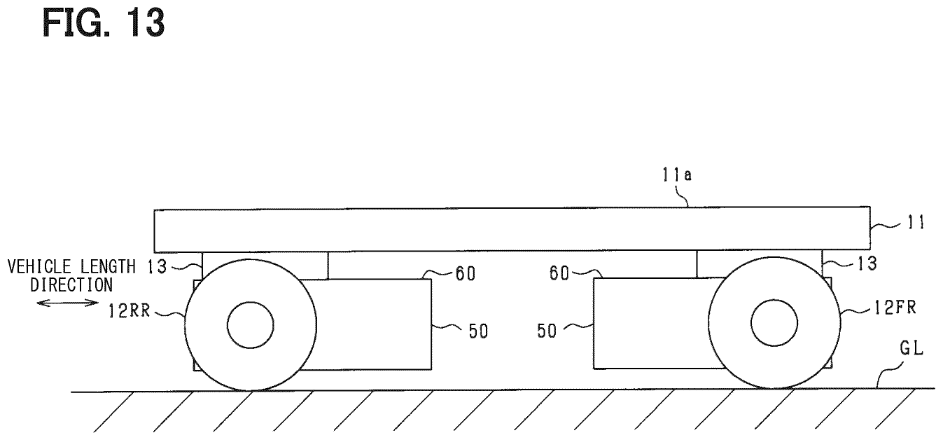

The unmanned carrier vehicle may be, for example, an unmanned carrier vehicle 10a shown in FIGS. 12 and 13. In this unmanned carrier vehicle 10a, each pair of electric drive devices 20 arranged in the vehicle width direction are positioned so that the electric motors 30 of these electric drive devices 20 face each other in the vehicle width direction, and the output shafts 72b of these electric drive devices 20 are aligned in the vehicle width direction. In the example shown in FIGS. 12 and 13, the electric drive device 20, which drives the right front wheel 12FR, and the electric drive device 20, which drives the left rear wheel 12RL, are arranged such that the top plate 69 of each of these electric drive devices 20 faces upward. In contrast, the electric drive device 20, which drives the left front wheel 12FL, and the electric drive device 20, which drives the right rear wheel 12RR, are arranged such that the bottom plate 66 of each of these electric drive devices 20 faces upward.

The unmanned carrier vehicle is not limited to the four-wheeled vehicle. It may be a six-wheeled vehicle with three pairs of drive wheels (wherein each pair of drive wheels are arranged in the vehicle width direction) or a two-wheeled vehicle with one pair of drive wheels. Additionally, the unmanned carrier vehicle is not limited to the unmanned carrier vehicle having all wheels as the drive wheels. It may be an unmanned carrier vehicle having one or more of the wheels as the driven wheel(s).

The unmanned carrier vehicle used in the factories is not limited to the AGV but may be an Autonomous Mobile Robot (AMR).

Additionally, the compact mobility is not limited to the unmanned carrier vehicle but may be a compact electric vehicle such as an electric wheelchair or a senior car. The compact electric vehicle is, for example, a vehicle with a travel speed of 10 km/h or less.

The controller device and its control method of the present disclosure may be realized by a dedicated computer that is provided by configuring at least one processor and a memory programmed to perform one or more functions embodied by a computer program. Alternatively, the controller device and its control method of the present disclosure may be realized by a dedicated computer that is provided by configuring at least one processor with one or more dedicated hardware logic circuits. Further alternatively, the controller device and its control method of the present disclosure may be realized by one or more dedicated computers that are provided by configuring a combination of: a processor programmed to perform one or more functions and a memory; and a processor composed of one or more hardware logic circuits. Further, the computer program may also be stored in a computer-readable, non-transitory, tangible storage medium as instructions to be executed by a computer.

Hereinafter, characteristic configurations, which can be extracted from one or more of the embodiments described above, will be indicated.

### (First Configuration)

According to a first configuration, there is provided a transmission including:
an input shaft;
an output shaft that extends in an extending direction of the input shaft;
a transmission mechanism that is configured to change a rotational speed of rotation outputted from the input shaft, and to transmit the rotation to the output shaft;
a case that receives the input shaft, the output shaft and the transmission mechanism; and
a brake mechanism that is configured to apply a braking torque to at least one of the input shaft and the output shaft, wherein the brake mechanism is received at an inside of the case.

### (Second Configuration)

According to a second configuration, there is provided the transmission according to the first configuration, wherein:
the transmission mechanism is a speed reducer mechanism that is configured to reduce the rotational speed of the rotation outputted from the input shaft, and to transmit the rotation to the output shaft; and
the brake mechanism is configured to apply the braking torque to the input shaft among the input shaft and the output shaft.

### (Third Configuration)

According to a third configuration, there is provided the transmission according to the second configuration, wherein the brake mechanism includes:
a rotator that is installed to the input shaft and is configured to rotate integrally with the input shaft;
at least one presser that is configured to apply the braking torque to the input shaft when the at least one presser is brought in contact with the rotator, and to stop application of the braking torque to the input shaft when the at least one presser is separated from the rotator; and
a position shifter that is configured to be electrically operated to shift the at least one presser between:
   a contact state where the at least one presser contacts the rotator; and
   a separate state where the at least one presser is separated from the rotator, wherein the position shifter is received at the inside of the case.

### (Fourth Configuration)

According to a fourth configuration, there is provided the transmission according to the third configuration, wherein:
the rotator is a brake drum;
the brake mechanism includes:
   a first brake shoe that has an arcuate portion which is opposed to and extends along one section of an inner peripheral surface of the brake drum;
   a second brake shoe that has an arcuate portion which is opposed to and extends along another section of the inner peripheral surface of the brake drum that is diametrically opposite to the one section of the inner peripheral surface of the brake drum about the input shaft;
   an anchor that is configured to rotatably support each of a first end portion of the first brake shoe and a first end portion of the second brake shoe to enable rotation of the first end portion of the first brake shoe and the first end portion of the second brake shoe relative to the case around an axis extending in the extending direction of the input shaft; and
   an urging element that is configured to apply a resilient force to the first brake shoe and the second brake shoe to move a second end portion of the first brake shoe and a second end portion of the second brake shoe toward each other, wherein:
the at least one presser is two pressers formed as two linings respectively provided to the arcuate portion of the first brake shoe and the arcuate portion of the second brake shoe; and
the position shifter is configured to shift the two linings between:
   the contact state where the two linings are brought in contact with the inner peripheral surface of the brake drum when the first brake shoe and the second brake shoe are pushed apart by the position shifter to move the second end portion of the first brake shoe and the second end portion of the second brake shoe away from each other; and
   the separate state where the two linings are separated from the inner peripheral surface of the brake drum when the second end portion of the first brake shoe and the second end portion of the second brake shoe are moved toward each other by the position shifter.

### (Fifth Configuration)

According to a fifth configuration, there is provided the transmission according to the fourth configuration, wherein:
the position shifter includes:
   a cam that has a major axis direction extending along a major axis of the cam and a minor axis direction extending along a minor axis of the cam;
   a support portion that is configured to rotatably support the cam to enable rotation of the cam around an axis extending in the extending direction of the input shaft;
   a lever; and
   an actuator that includes:
      a main body; and
      a movable portion which is configured to move in a linear direction relative to the main body, wherein:
the lever couples between the cam and the movable portion;
when the cam is placed in a first state where one primary end portion of the cam facing in the major axis direction contacts the second end portion of the first brake shoe, and one secondary end portion of the cam facing opposite to the one primary end portion of the cam in the major axis direction contacts the second end portion of the second brake shoe, the first brake shoe and the second brake shoe are pushed apart to bring the two linings in contact with the inner peripheral surface of the brake drum;
when the cam is placed in a second state where another primary end portion of the cam facing in the minor axis direction contacts the second end portion of the first brake shoe, and another secondary end portion of the cam facing opposite to the another primary end portion of the cam in the minor axis direction contacts the second end portion of the second brake shoe, the second end portion of the first brake shoe and the second end portion of the second brake shoe are moved toward each other to separate the two linings from the inner peripheral surface of the brake drum; and
the position shifter is configured to place the cam in the first state by placing a distal end portion of the movable portion to a first position, and to place the cam in the second state by placing the distal end portion of the movable portion to a second position that is closer to the main body than the first position.

### (Sixth Configuration)

According to a sixth configuration, there is provided the transmission according to the fifth configuration, wherein:
the case is shaped in a form where a direction, which is perpendicular to both the input shaft and the output shaft, is a longitudinal direction of the case;
the input shaft and the output shaft are arranged one after another in the longitudinal direction of the case;
the speed reducer mechanism includes:
   an input-side spur gear that is installed to the input shaft; and
   an output-side spur gear that is installed to the output shaft and has a diameter larger than a diameter of the input-side spur gear, wherein:
at the inside of the case, the actuator is placed on an opposite side of the input shaft which is opposite to the output shaft;
the movable portion is configured to move in a direction that is perpendicular to both the longitudinal direction of the case and the input shaft; and
the cam and the support portion are positioned farther from the input shaft than the input-side spur gear in a direction directed from the input shaft toward the cam.

### (Seventh Configuration)

According to seventh configuration, there is provided the transmission according to the fifth configuration or the sixth configuration, wherein:
the actuator is a solenoid coil that includes:
   a coil unit provided as the main body; and
   a movable iron core provided as the movable portion;
the position shifter includes a spring that is configured to apply the resilient force to the lever to place the movable portion to the first position; and
the position shifter is configured to place the movable portion to the second position when the main body is energized, and to place the movable portion to the first position when the main body is deenergized.

### (Eighth Configuration)

According to an eighth configuration, there is provided the transmission according to the seventh configuration, wherein:
the movable portion is configured to move in a direction that is perpendicular to both a longitudinal direction of the case and the input shaft; and
the spring extends in a moving direction of the movable portion, wherein the spring and the solenoid coil are arranged one after another in the extending direction of the input shaft.

### (Ninth Configuration)

According to a ninth configuration, there is provided an electric drive device to be installed in a vehicle, the electric drive device including:
the transmission of any one of the fifth configuration to the eighth configuration; and
an electric motor that is configured to apply a rotational torque to the input shaft of the transmission.

### (Tenth Configuration)

According to a tenth configuration, there is provided a vehicle system including the electric drive device of the ninth configuration as one of a plurality of electric drive devices in the vehicle system, wherein:
in each of the plurality of electric drive devices, the output shaft extends to an outside of the case from an output-side opening of the case adjacent to a first end portion of the case which faces in a longitudinal direction of the case;
in each of the plurality of electric drive devices, the input shaft extends toward an input-side opening of the case adjacent to a second end portion of the case opposite to the first end portion of the case in the longitudinal direction of the case;
in each of the plurality of electric drive devices, the input-side opening is located on an opposite side which is opposite to the output-side opening relative to an axis extending in the longitudinal direction of the case;
in each of the plurality of electric drive devices, the electric motor is installed in the case at a location where the input-side opening is placed;
in each of the plurality of electric drive devices, a corresponding drive wheel of the vehicle is coupled to the output shaft;
among the plurality of electric drive devices, a right electric drive device, which is configured to rotate the corresponding drive wheel located on a right side of the vehicle, and a left electric drive device, which is configured to rotate the corresponding drive wheel located on a left side of the vehicle, are installed at a vehicle body and are arranged one after another in a vehicle width direction of the vehicle; and
the right electric drive device and the left electric drive device, which are arranged one after another in the vehicle width direction, are placed such that the longitudinal direction of the case of the right electric drive device and the longitudinal direction of the case of the left electric drive device are directed in a vehicle length direction of the vehicle.

### (Eleventh Configuration)

According to an eleventh configuration, there is provided the vehicle system according to the tenth configuration, wherein a dimension of the vehicle body measured in the vehicle width direction is smaller than a dimension of the vehicle body measured in the vehicle length direction.

### (Twelfth Configuration)

According to a twelfth configuration, there is provided the vehicle system according to the ninth configuration or the tenth configuration, wherein the vehicle is an unmanned carrier vehicle used in a workplace.

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A transmission comprising:
an input shaft;
an output shaft that extends in an extending direction of the input shaft;
a transmission mechanism that is configured to change a rotational speed of rotation outputted from the input shaft, and to transmit the rotation to the output shaft;
a case that receives the input shaft, the output shaft and the transmission mechanism; and
a brake mechanism that is configured to apply a braking torque to at least one of the input shaft and the output shaft, wherein the brake mechanism is received at an inside of the case.

2. The transmission according to claim 1, wherein:
the transmission mechanism is a speed reducer mechanism that is configured to reduce the rotational speed of the rotation outputted from the input shaft, and to transmit the rotation to the output shaft; and
the brake mechanism is configured to apply the braking torque to the input shaft among the input shaft and the output shaft.

3. The transmission according to claim 2, wherein the brake mechanism includes:
a rotator that is installed to the input shaft and is configured to rotate integrally with the input shaft;
at least one presser that is configured to apply the braking torque to the input shaft when the at least one presser is brought in contact with the rotator, and to stop application of the braking torque to the input shaft when the at least one presser is separated from the rotator; and
a position shifter that is configured to be electrically operated to shift the at least one presser between:
a contact state where the at least one presser contacts the rotator; and
a separate state where the at least one presser is separated from the rotator, wherein the position shifter is received at the inside of the case.

4. The transmission according to claim 3, wherein:
the rotator is a brake drum;
the brake mechanism includes:
a first brake shoe that has an arcuate portion which is opposed to and extends along one section of an inner peripheral surface of the brake drum;
a second brake shoe that has an arcuate portion which is opposed to and extends along another section of the inner peripheral surface of the brake drum that is diametrically opposite to the one section of the inner peripheral surface of the brake drum about the input shaft;
an anchor that is configured to rotatably support each of a first end portion of the first brake shoe and a first end portion of the second brake shoe to enable rotation of the first end portion of the first brake shoe and the first end portion of the second brake shoe relative to the case around an axis extending in the extending direction of the input shaft; and
an urging element that is configured to apply a resilient force to the first brake shoe and the second brake shoe to move a second end portion of the first brake shoe and a second end portion of the second brake shoe toward each other, wherein:
the at least one presser is two pressers formed as two linings respectively provided to the arcuate portion of the first brake shoe and the arcuate portion of the second brake shoe; and
the position shifter is configured to shift the two linings between:
the contact state where the two linings are brought in contact with the inner peripheral surface of the brake drum when the first brake shoe and the second brake shoe are pushed apart by the position shifter to move the second end portion of the first brake shoe and the second end portion of the second brake shoe away from each other; and
the separate state where the two linings are separated from the inner peripheral surface of the brake drum when the second end portion of the first brake shoe and the second end portion of the second brake shoe are moved toward each other by the position shifter.

5. The transmission according to claim 4, wherein:
the position shifter includes:
a cam that has a major axis direction extending along a major axis of the cam and a minor axis direction extending along a minor axis of the cam;
a support portion that is configured to rotatably support the cam to enable rotation of the cam around an axis extending in the extending direction of the input shaft;
a lever; and
an actuator that includes:
a main body; and
a movable portion which is configured to move in a linear direction relative to the main body, wherein:
the lever couples between the cam and the movable portion;
when the cam is placed in a first state where one primary end portion of the cam facing in the major axis direction contacts the second end portion of the first brake shoe, and one secondary end portion of the cam facing opposite to the one primary end portion of the cam in the major axis direction contacts the second end portion of the second brake shoe, the first brake shoe and the second brake shoe are pushed apart to bring the two linings in contact with the inner peripheral surface of the brake drum;
when the cam is placed in a second state where another primary end portion of the cam facing in the minor axis direction contacts the second end portion of the first brake shoe, and another secondary end portion of the cam facing opposite to the another primary end portion of the cam in the minor axis direction contacts the second end portion of the second brake shoe, the second end portion of the first brake shoe and the second end portion of the second brake shoe are moved toward each other to separate the two linings from the inner peripheral surface of the brake drum; and
the position shifter is configured to place the cam in the first state by placing a distal end portion of the movable portion to a first position, and to place the cam in the second state by placing the distal end portion of the movable portion to a second position that is closer to the main body than the first position.

6. The transmission according to claim 5, wherein:
the case is shaped in a form where a direction, which is perpendicular to both the input shaft and the output shaft, is a longitudinal direction of the case;
the input shaft and the output shaft are arranged one after another in the longitudinal direction of the case;
the speed reducer mechanism includes:
an input-side spur gear that is installed to the input shaft; and
an output-side spur gear that is installed to the output shaft and has a diameter larger than a diameter of the input-side spur gear, wherein:
at the inside of the case, the actuator is placed on an opposite side of the input shaft which is opposite to the output shaft;
the movable portion is configured to move in a direction that is perpendicular to both the longitudinal direction of the case and the input shaft; and
the cam and the support portion are positioned farther from the input shaft than the input-side spur gear in a direction directed from the input shaft toward the cam.

7. The transmission according to claim 5, wherein:
the actuator is a solenoid coil that includes:
a coil unit provided as the main body; and
a movable iron core provided as the movable portion;
the position shifter includes a spring that is configured to apply the resilient force to the lever to place the movable portion to the first position; and
the position shifter is configured to place the movable portion to the second position when the main body is energized, and to place the movable portion to the first position when the main body is deenergized.

8. The transmission according to claim 7, wherein:
the movable portion is configured to move in a direction that is perpendicular to both a longitudinal direction of the case and the input shaft; and
the spring extends in a moving direction of the movable portion, wherein the spring and the solenoid coil are arranged one after another in the extending direction of the input shaft.

9. An electric drive device to be installed in a vehicle, the electric drive device comprising:
the transmission of claim 5; and
an electric motor that is configured to apply a rotational torque to the input shaft of the transmission.

10. A vehicle system comprising the electric drive device of claim 9 as one of a plurality of electric drive devices in the vehicle system, wherein:
in each of the plurality of electric drive devices, the output shaft extends to an outside of the case from an output-side opening of the case adjacent to a first end portion of the case which faces in a longitudinal direction of the case;
in each of the plurality of electric drive devices, the input shaft extends toward an input-side opening of the case adjacent to a second end portion of the case opposite to the first end portion of the case in the longitudinal direction of the case;
in each of the plurality of electric drive devices, the input-side opening is located on an opposite side which is opposite to the output-side opening relative to an axis extending in the longitudinal direction of the case;
in each of the plurality of electric drive devices, the electric motor is installed in the case at a location where the input-side opening is placed;
in each of the plurality of electric drive devices, a corresponding drive wheel of the vehicle is coupled to the output shaft;
among the plurality of electric drive devices, a right electric drive device, which is configured to rotate the corresponding drive wheel located on a right side of the vehicle, and a left electric drive device, which is configured to rotate the corresponding drive wheel located on a left side of the vehicle, are installed at a vehicle body and are arranged one after another in a vehicle width direction of the vehicle; and
the right electric drive device and the left electric drive device, which are arranged one after another in the vehicle width direction, are placed such that the longitudinal direction of the case of the right electric drive device and the longitudinal direction of the case of the left electric drive device are directed in a vehicle length direction of the vehicle.

11. The vehicle system according to claim 10, wherein a dimension of the vehicle body measured in the vehicle width direction is smaller than a dimension of the vehicle body measured in the vehicle length direction.

12. The vehicle system according to claim 10, wherein the vehicle is an unmanned carrier vehicle used in a workplace.
